(19) United States
(12) Patent Application Publication
(10) Pub. No.: US 2025/0344082 A1
(43) Pub. Date: Nov. 6, 2025

(54) SYSTEMS AND METHODS FOR MAPPING NETWORK IDENTIFIERS AND MOBILE TERMINAL IDENTIFIERS IN A WIRED SIMULATION ENVIRONMENT

(71) Applicant: Verizon Patent and Licensing Inc., Basking Ridge, NJ (US)

(72) Inventors: Mourad B. TAKLA, Hillsborough, NJ (US); Sankrith SUBRAMANIAN, St. Petersburg, FL (US); Xiong YANG, Berkeley Heights, NJ (US)

(73) Assignee: Verizon Patent and Licensing Inc., Basking Ridge, NJ (US)

(21) Appl. No.: 18/655,718

(22) Filed: May 6, 2024

(51) Int. Cl. H04W 24/06; H04W 36/08; H04W 74/0833

(52) U.S. Cl. CPC H04W 24/06; H04W 36/08; H04W 74/0833

(57) ABSTRACT

In some implementations, a base station (BS) operating in a wired simulation framework may identify a packet that is received from a mobile terminal (MT) in the wired simulation framework or is to be transmitted to the MT. The BS may map a mobile terminal identifier (MTID) associated with the packet to a radio network temporary identifier (RNTI) associated with the packet, or vice versa, using one of a first table or a second table, respectively. The BS may decode or transmit the packet based on the mapping.

### BACKGROUND

Network simulation may be used to replicate a behavior of a wireless network. Network simulation may be used to analyze interactions between different network entities, such as nodes, access points, and so on, to assess a performance of the wireless network under different operating conditions. Network simulation may be used to assess a wireless network performance, identify potential problems, and/or resolve problems prior to a deployment of the wireless network.

### BRIEF DESCRIPTION OF THE DRAWINGS

FIG. 1 is a diagram of an example associated with a communication between a base station (BS) and a mobile terminal (MT).

FIGS. 2-4 are diagrams of examples associated with mapping radio network temporary identifiers (RNTIs) and MT identifiers (MTIDs) in a wired simulation environment.

FIGS. 5A-5D are diagrams of examples associated with mapping RNTIs and MTIDs in a wired simulation environment.

FIGS. 6A-6D are diagrams of examples associated with mapping RNTIs and MTIDs in a wired simulation environment.

FIGS. 7A-7H are diagrams of examples associated with mapping RNTIs and MTIDs in a wired simulation environment.

FIG. 8 is a diagram of an example environment in which systems and/or methods described herein may be implemented.

FIG. 9 is a diagram of example components of one or more devices of FIG. 8.

FIG. 10 is a flowchart of an example process associated with mapping radio network temporary identifiers (RNTIs) and mobile terminal identifiers (MTIDs) in a wired simulation environment.

### DETAILED DESCRIPTION OF EXAMPLE EMBODIMENTS

The following detailed description of example implementations refers to the accompanying drawings. The same reference numbers in different drawings may identify the same or similar elements.

A BS and an MT may be connected using a wired infrastructure, where the wired infrastructure may be associated with a wired simulation framework. When the BS and the MT are connected using the wired infrastructure, the BS may need to determine an identity of the MT before processing a packet that is sent by the MT.

In wireless communication over the air, the MT may use multiple RNTIs for this purpose based on its link context. The BS may use baseband processing algorithms to identify the MT using the RNTI, and subsequently, the BS may decode a packet that is sent by the MT.

In a wired simulation environment, based on a routing/switching framework employed, an identifier (ID) for the MT (referred to as an MTID) and an ID for the BS (referred to as a BS ID (BSID)) may be defined for packet transport purposes. The MT/BS IDs may be, for example, Internet Protocol (IP) addresses.

When the BS receives multiple packets from different MTs, a received packet may contain a corresponding MTID (e.g., an ID of an MT that sent a particular packet). Each of the packets may be identified in terms of RNTI. The BS should be able to map an MTID associated with a received packet to an RNTI. Similarly, when the BS transmits packets, the BS should be able to map an RNTI associated with a transmitted packet to an MTID. However, the BS may not be able to properly map between MTIDs and RNTIs, or vice versa, in the wired simulation environment, which may prevent the BS for receiving or transmitting packets in the wired simulation environment. In some cases, an RNTI may be the same across multiple MTs, where the RNTI may be assigned by the BS or generated by an MT, and the BS may be unable to handle the same RNTI. Further, a mapping between MTIDs and RNTIs, or vice versa, at the BS may involve a large variety of wireless contexts, and the mapping should be utilized to enable seamless operation in the wired simulation environment.

In some implementations, RNTIs may be mapped to MTIDs, or MTIDs may be mapped to RNTIs, in a BS operating in a wired simulation framework. The BS may use either a first hash table or a second hash table. The first hash table may be used for mapping an RNTI to an MTID. The second hash table may be used for mapping an MTID to an RNTI. The BS may perform various operations in a given hash table, such as a get operation, an update operation, a find operation, and/or a delete operation. An RNTI may include a random access RNTI (RA-RNTI), a temporary cell RNTI (TC-RNTI), or a cell RNTI (C-RNTI). By using different hash tables, different elements within the wired simulation framework may be able to correctly communicate with each other.

In some implementations, in an RNTI-to-MTID hash table, a hash algorithm of h(key)=key % 64K may be used, where key=RNTI, and a hash table size may equal 64K×(2B+(MAX_MT_PER_RNTI×4B)), where MAX_MT_PER_RNTI indicates a maximum number of MTs per RNTI and B indicates bytes. In an MTID-to-RNTI hash table, a hash algorithm of h(key)=key % MAX_MT_NETWORK may be used, where key=MTID, and a hash table size may equal MAX_MT_NETWORK×(4B+(MAX_RNTI_PER_MT×(2B+1B))), where MAX_MT_NETWORK indicates a maximum number of MTs in a network and MAX_RNTI_PER_MT indicates a maximum number of RNTIs per MT. As an example, 1B or 2B of memory may be allocated for an RNTI, and 4B of memory may be allocated for an MTID. In some implementations, the BS may perform a mapping between RNTIs and MTIDs, or vice versa, for various scenarios, which may include a random access procedure, handover, duplicate RNTIs, and/or multiple RNTIs.

In some implementations, by employing the RNTI-to-MTID hash table and the MTID-to-RNTI hash table, the BS may be able to perform RNTI-to-MTID mappings and MTID-to-RNTI mappings, respectively, which may allow the BS to decode/receive or transmit packets, respectively, to the MT within the wired simulation environment. The RNTI-to-MTID hash table and the MTID-to-RNTI hash table may allow the BS and the MT within the wired simulation environment to correctly communicate with each other, thereby improving a simulation performance.

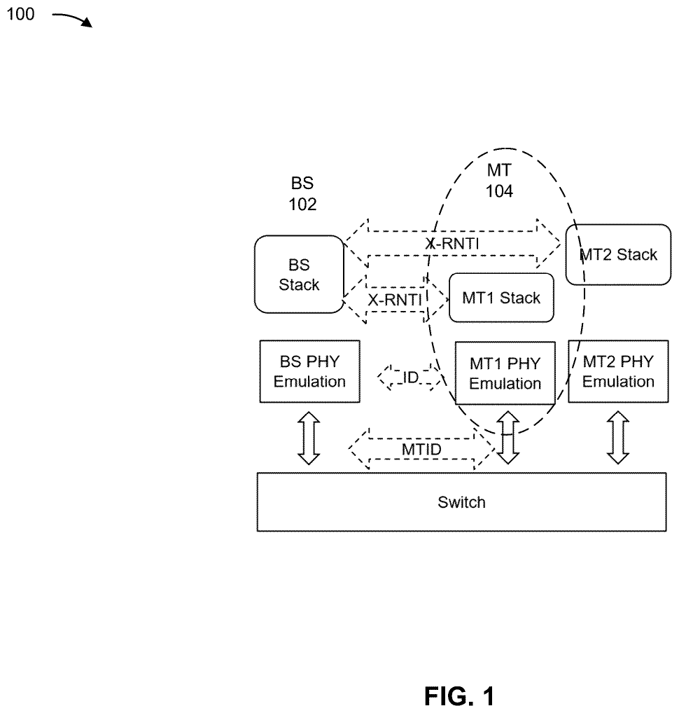

FIG. 1 is a diagram of an example 100 associated with a communication between a BS 102 and an MT 104. The BS 102 may include a BS stack and a BS physical (PHY) emulation layer. The MT 104 may include an MT stack and an MT emulation layer.

As shown in FIG. 1, stacks may identify each other using multiple RNTIs. A PHY layer responsible for communicating between components may translate an RNTI to an MTID, while maintaining the flexibility of allowing any MT to communicate with any BS. The MT 104 may communicate with the BS 102 using a specific RNTI, and the BS 102 may respond with a different RNTI, where the different RNTI may be decoded and maintained by a PHY layer to allow for the proper delivery of a message to a destination.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

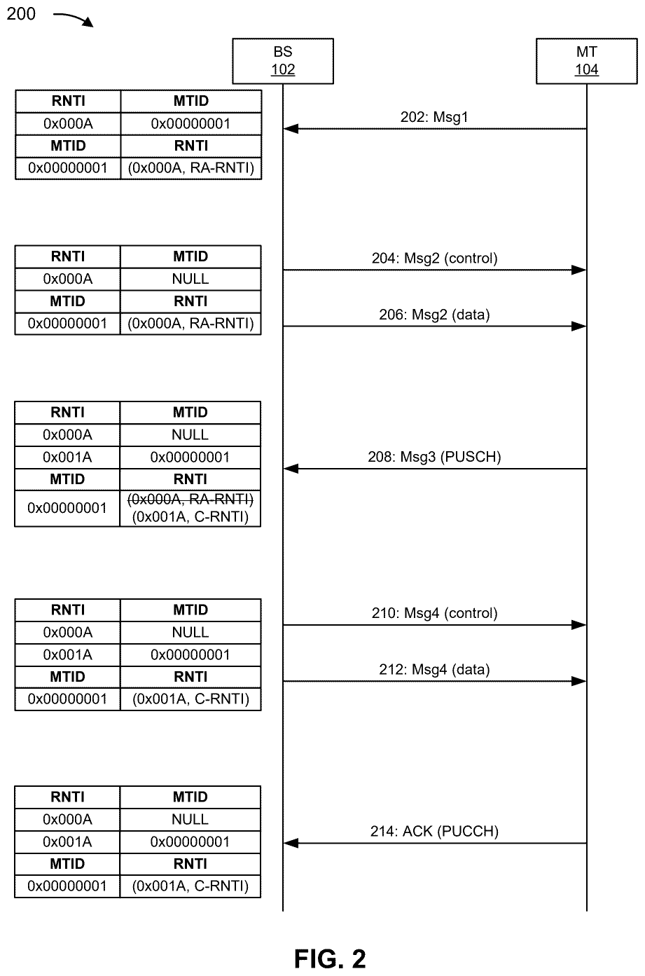

FIG. 2 is a diagram of an example 200 associated with mapping RNTIs and MTIDs in a wired simulation environment. As shown in FIG. 2, example 200 includes a BS 102 and an MT 104.

In some implementations, in an initial BS access by the MT 104, the MT 104 may initially follow a random access procedure to access the BS 102. During the random access procedure, the MT 104 may transmit a message 1 (Msg1) (e.g., an initial message) to the BS 102. The Msg1 may contain a preamble signature that is selected by the MT 104. The MT 104 may select the preamble from N unique preambles. Depending on a time and frequency at which the Msg1 is sent, a corresponding RNTI (e.g., an RA-RNTI) may exist. The BS 102 may independently calculate the RA-RNTI based on a frequency and time instant at which the preamble was transmitted by the MT 104. The BS 102 may issue a message 2 (Msg2) (e.g., a random access response (RAR)) using the RA-RNTI that was calculated based on the Msg1. The Msg2 may include a TC-RNTI. The MT 104 may transmit, to the BS 102, a message 3 (Msg3) based on a time and frequency allocation that was made by the BS 102 in the Msg2. The Msg3 may include the TC-RNTI. The BS 102 may transmit, to the MT 104, a message 4 (Msg4) in response to a successfully received Msg3. The MT 104 may transmit, to the BS 102, an acknowledgement (ACK) to acknowledge a reception of the Msg4. At this point, the MT 104 may be synchronized with the BS 102.

As shown by reference number 202, when a random access procedure is not associated with contention (e.g., only one MT 104 may be trying to access the BS 102), the BS 102 may receive the Msg1 from the MT 104. The MT 104 may be associated with an MTID of 0x00000001. The Msg1 may be a physical random access channel (PRACH) preamble with an RA-RNTI of 0x000A. The BS 102 may maintain an RNTI-to-MTID hash table and an MTID-to-RNTI hash table, where the RNTI-to-MTID hash table may be used for an RNTI-to-MTID mapping and the MTID-to-RNTI hash table may be used for an MTID-to-RNTI mapping. For example, the BS 102 may perform operations of UPDATE(MTID-to-RNTI, 0x00000001, (0x000A, RA-RNTI)) and UPDATE(RNTI-to-MTID, 0x000A, 0x00000001).

As shown by reference number 204, the BS 102 may transmit, to the MT 104, a Msg2 (control). The Msg2 (control) may be a unicast message. A cyclic redundancy check (CRC) of a downlink control information (DCI) (e.g., DCI associated with format 1_0) may be scrambled with the RA-RNTI of 0x000A (based on the RA-RNTI calculated for the Msg1).

As shown by reference number 206, the BS 102 may transmit, to the MT 104, a Msg2 (data). The Msg2 (data) may be a unicast message. The Msg2 (data) may contain a TC-RNTI among other information elements (IEs). For example, the BS 102 may perform an operation of DELETE(RNTI-to-MTID, 0x00000001).

As shown by reference number 208, the BS 102 may receive the Msg3 from the MT 104. The Msg3 may be associated with a physical uplink shared channel (PUSCH) transmission. The Msg3 may be with a TC-RNTI of 0x001A. For example, the BS 102 may perform operations of DELETE(MTID-to-RNTI, (0x000A, RA-RNTI)), UPDATE(MTID-to-RNTI, 0x00000001, (0x001A, C-RNTI)), and UPDATE(RNTI-to-MTID, 0x001A, 0x00000001).

As shown by reference number 210, the BS 102 may transmit, to the MT 104, a Msg4 (control). The Msg4 (control) may be a unicast message. A CRC of DCI (e.g., DCI associated with format 1_0) may be scrambled with the TC-RNTI of 0x000A.

As shown by reference number 212, the BS 102 may transmit, to the MT 104, a Msg4 (data). The Msg4 (data) may be a unicast message and may be associated with a contention resolution.

As shown by reference number 214, the BS 102 may receive an ACK transmission from the MT 104. The ACK may be associated with a physical uplink control channel (PUCCH) transmission. The TC-RNTI may become a C-RNTI after the ACK transmission is received by the BS 102 (e.g., the BS 102 may not recognize that the TC-RNTI becomes the C-RNTI).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

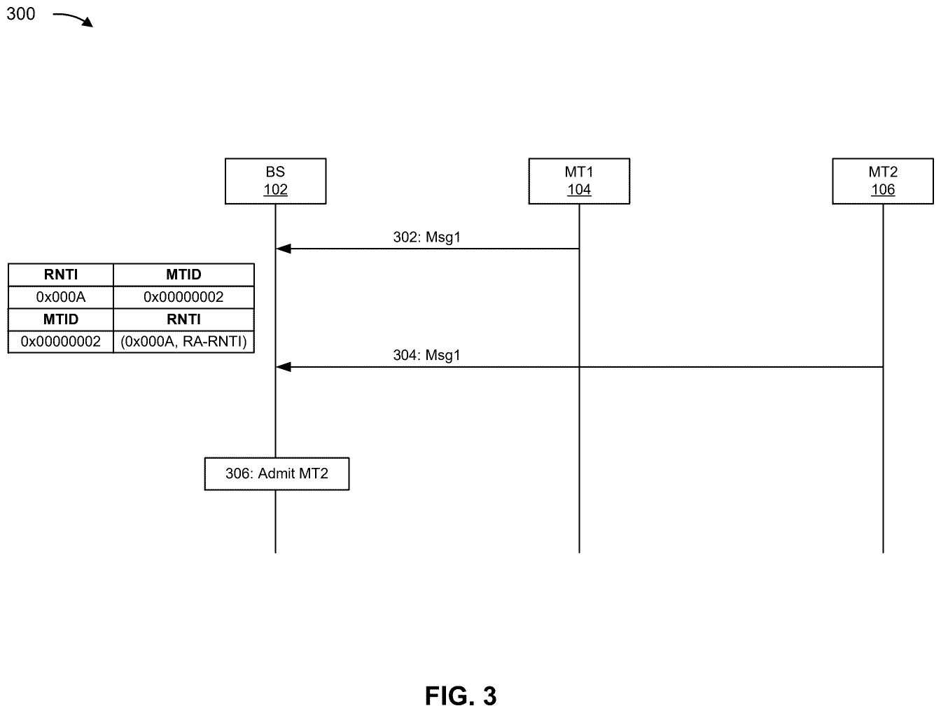

FIG. 3 is a diagram of an example 300 associated with mapping RNTIs and MTIDs in a wired simulation environment. As shown in FIG. 3, example 300 includes a BS 102, a first MT (MT1) 104, and a second MT (MT2) 106.

In some implementations, a random access procedure for an initial MT access to the BS 102 may be associated with contention. During contention, a preamble of the first MT 104 may be the same as a preamble of the second MT 106.

As shown by reference number 302, the BS 102 may receive a Msg1 from the first MT 104. The first MT 104 may be associated with an MTID of 0x00000001. The Msg1 may be a PRACH preamble with an RA-RNTI of 0x000A. As shown by reference number 304, the BS 102 may receive a Msg1 from the second MT 106. The second MT 106 may be associated with an MTID of 0x00000002. The Msg1 may be a PRACH preamble with an RA-RNTI of 0x000A. In other words, the same preamble may be used by the first MT 104 and the second MT 106, which may result in a contention between Msg1s received by the BS 102 from the first MT 104 and the second MT 106. The BS 102 may maintain an RNTI-to-MTID hash table and an MTID-to-RNTI hash table, where the RNTI-to-MTID hash table may be used for an RNTI-to-MTID mapping and the MTID-to-RNTI hash table may be used for an MTID-to-RNTI mapping. As shown by reference number 306, the BS 102 may admit the second MT 106 based on a contention resolution. For example, the BS 102 may perform operations of UPDATE(MTID-to-RNTI, 0x00000002, (0x000A, RA-RNTI)) and UPDATE(RNTI-to-MTID, 0x000A, 0x00000002.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

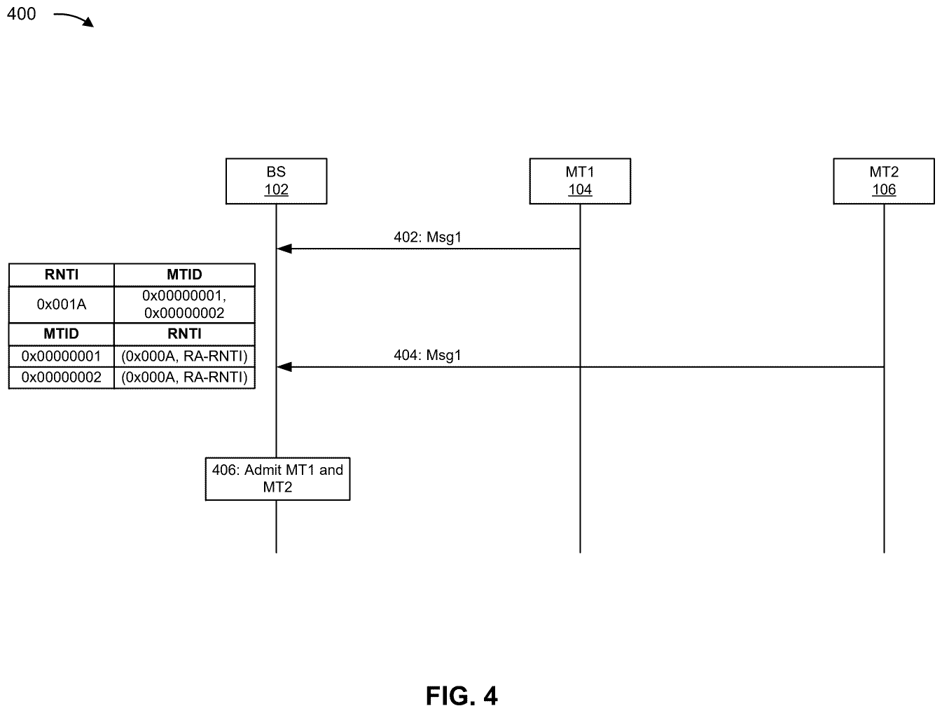

FIG. 4 is a diagram of an example 400 associated with mapping RNTIs and MTIDs in a wired simulation environment. As shown in FIG. 4, example 400 includes a BS 102, a first MT (MT1) 104, and a second MT (MT2) 106.

In some implementations, a random access procedure for an initial MT access to the BS 102 may be associated with no contention. In this example, a preamble of the first MT 104 may not be the same as a preamble of the second MT 106.

As shown by reference number 402, the BS 102 may receive a Msg1 from the first MT 104. The first MT 104 may be associated with an MTID of 0x00000001. The Msg1 may be a PRACH preamble with an RA-RNTI of 0x000A. As shown by reference number 404, the BS 102 may receive a Msg1 from the second MT 106. The second MT 106 may be associated with an MTID of 0x00000002. The Msg1 may be a PRACH preamble with an RA-RNTI of 0x000A. As shown by reference number 406, the BS 102 may admit the first MT 104 and the second MT 106. For example, the BS 102 may perform operations of UPDATE(MTID-to-RNTI, 0x00000001, (0x000A, RA-RNTI)), UPDATE(RNTI-to-MTID, 0x000A, 0x00000001), UPDATE(MTID-to-RNTI, 0x00000002, (0x000A, RA-RNTI)), and UPDATE(RNTI-to-MTID, 0x000A, 0x00000002.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

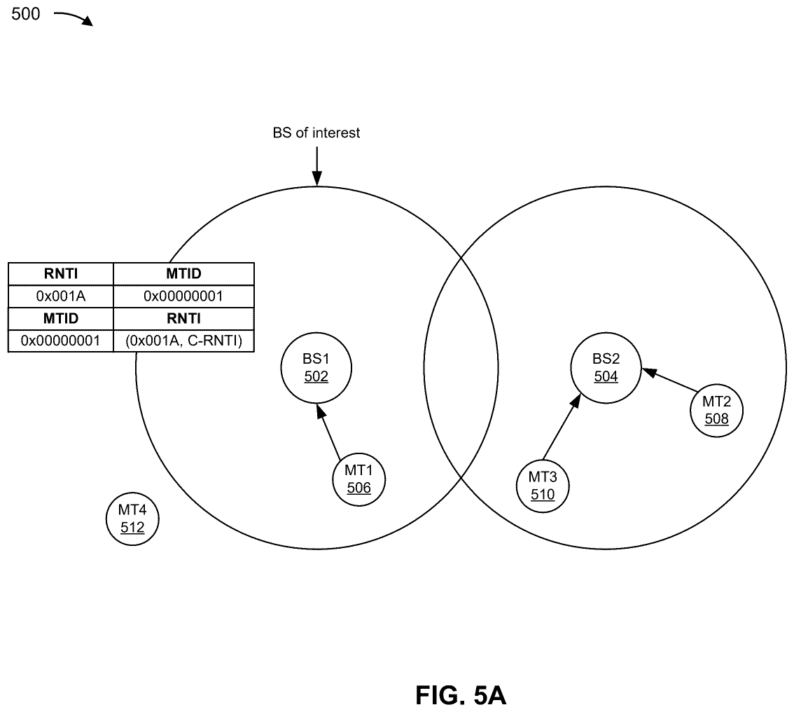

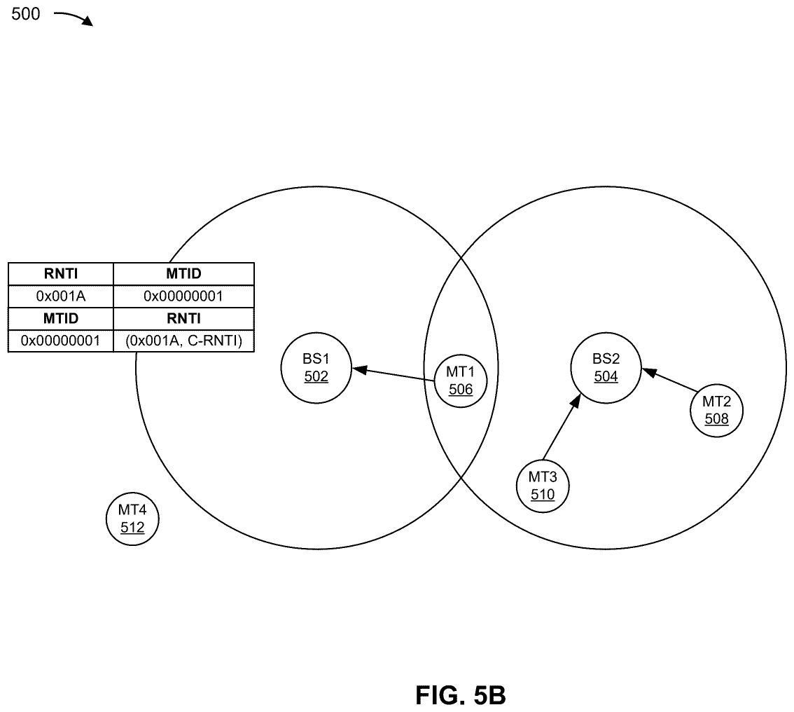

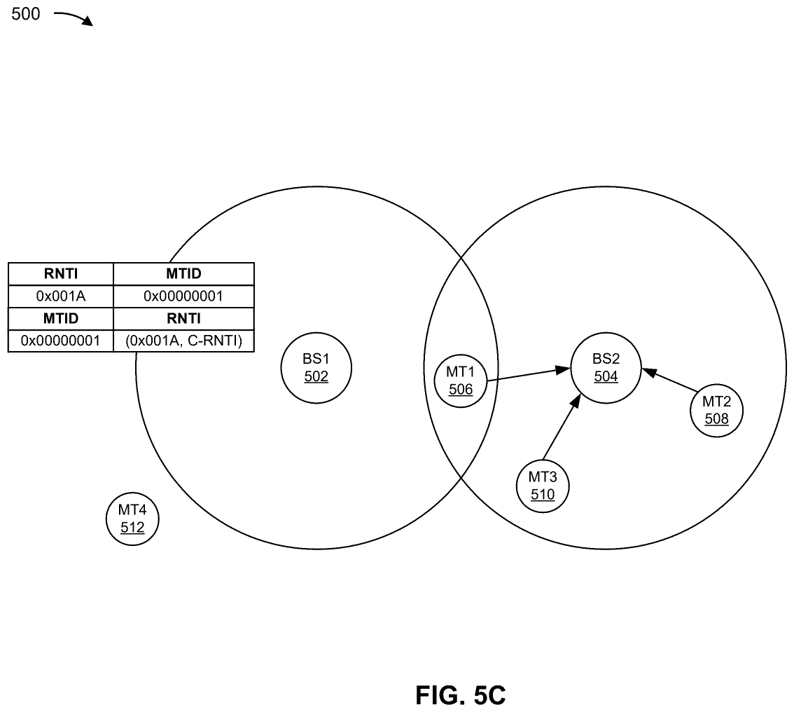

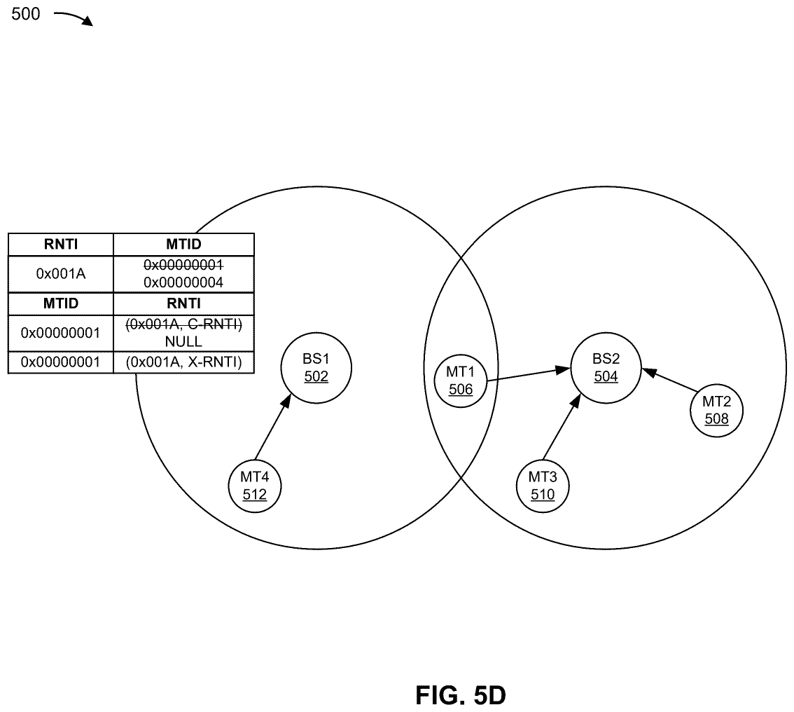

FIGS. 5A-5D are diagrams of an example 500 associated with mapping RNTIs and MTIDs in a wired simulation environment. As shown in FIGS. 5A-5D, example 500 includes a first BS (BS1) 502, a second BS (BS2) 504, a first MT (MT1) 506, a second MT (MT2) 508, a third MT (MT3) 510, and a fourth MT (MT4) 512.

In some implementations, in an MT handover from the first BS 502 to the second BS 504, the first MT 506 may be connected to the first BS 502 and choose to join the second BS 504 based the signal strength conditions. In such a case, the first MT 506 may disconnect from the first BS 502 and connect to the second BS 504. The first MT 506 may be served with respect to the first BS 502 when the first MT 506 is in a connected state, which may follow a synchronization state associated with a random access procedure. The first MT 506 may be reachable with respect to the first BS 502 when the first MT 506 is in coverage of the first BS 502. On the other hand, an unserved MT may be an MT that is not served by the first BS 502. The unreachable MT may be an MT that is outside the coverage of the first BS 502. In some implementations, a handover may involve the fourth MT 512 that is reachable but unserved.

As shown in FIG. 5A, the first MT 506 may be served by the first BS 502. The second MT 508 and the third MT 510 may be served by the second BS 504. The fourth MT 512 may be unreachable by the first BS 502. The first BS 502 may maintain an RNTI-to-MTID hash table and an MTID-to-RNTI hash table, where the RNTI-to-MTID hash table may be used for an RNTI-to-MTID mapping and the MTID-to-RNTI hash table may be used for an MTID-to-RNTI mapping. For example, the RNTI-to-MTID hash table may map 0x001A to 0x00000001, and the MTID-to-RNTI hash table may map 0x00000001 to (0x001A, C-RNTI). As shown in FIG. 5B, the first MT 506 may move to an edge of the first BS 502. At this point, the first MT 506 may still be served by the first BS 502. As shown in FIG. 5C, the first MT 506 may detach from the first BS 502 and attach to the second BS 504. As shown in FIG. 5D, the fourth MT 512 may become reachable with respect to the first BS 502. The fourth MT 512 may attach to the first BS 502 with an X-RNTI that is equal to a C-RNTI of the first MT 506, where X may be an RA-RNTI, a TC-RNTI, or a C-RNTI.

In some implementations, during a random access procedure of the fourth MT 512, when the X-RNTI is equal to the C-RNTI of the first MT 506, the first BS 502 may perform an operation associated with a deletion of stale entries. For example, if IS_SERVED(GET(RNTI-to-MTID,0x001A))=false, then the first BS 502 may perform operations of DELETE(MTID-to-RNTI, (0x001A, C-RNTI)) and DELETE(RNTI-to-MTID, 0x00000001). Further, the first BS 502 may update entries in the RNTI-to-MTID hash table and the MTID-to-RNTI hash table, which may be based on the first MT 506 detaching from the first BS 502 and the fourth MT 512 attaching to the first BS 502.

As indicated above, FIGS. 5A-5D are provided as an example. Other examples may differ from what is described with regard to FIGS. 5A-5D. The number and arrangement of devices shown in FIGS. 5A-5D are provided as an example. In practice, there may be additional devices, fewer devices, different devices, or differently arranged devices than those shown in FIGS. 5A-5D. Furthermore, two or more devices shown in FIGS. 5A-5D may be implemented within a single device, or a single device shown in FIGS. 5A-5D may be implemented as multiple, distributed devices. Additionally, or alternatively, a set of devices (e.g., one or more devices) shown in FIGS. 5A-5D may perform one or more functions described as being performed by another set of devices shown in FIGS. 5A-5D.

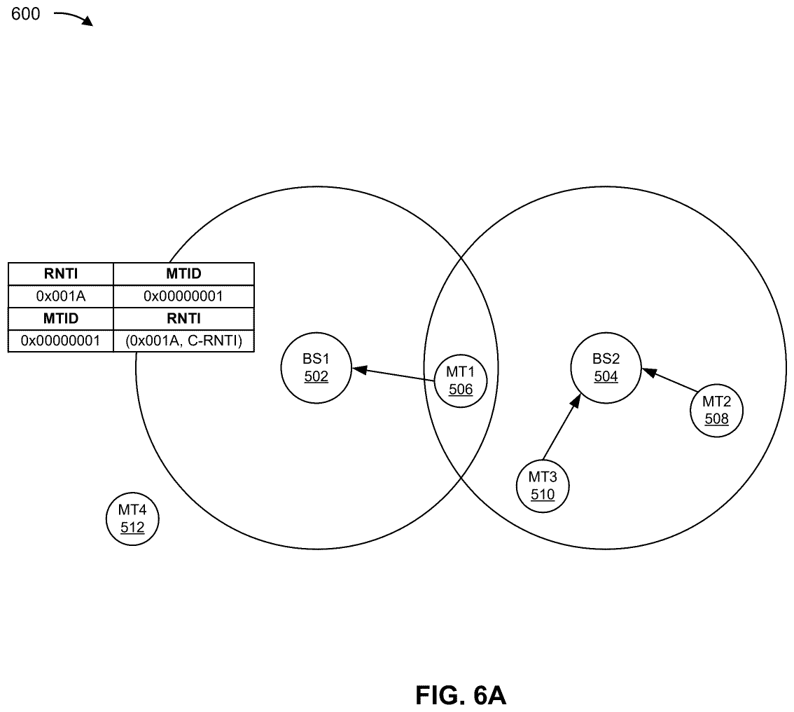

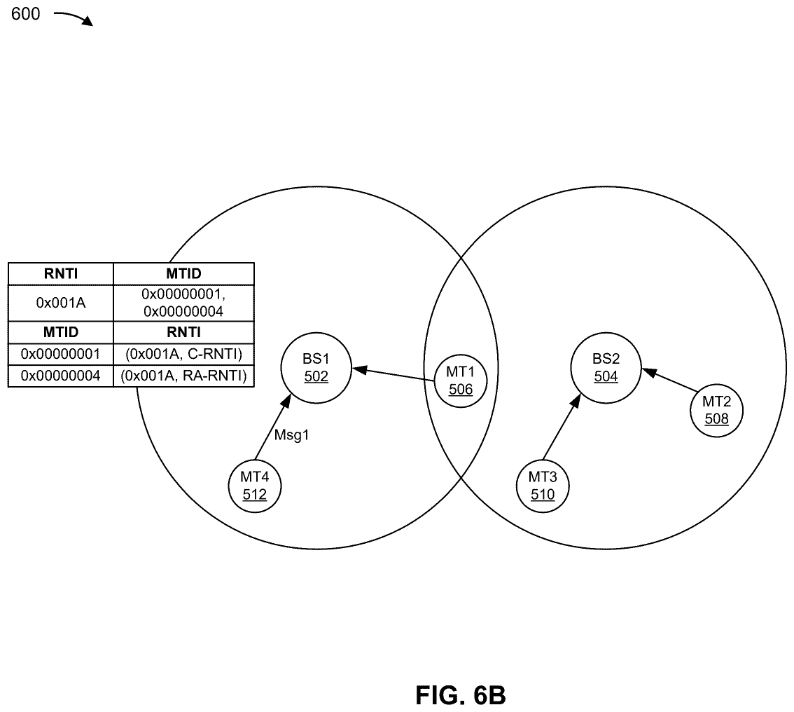

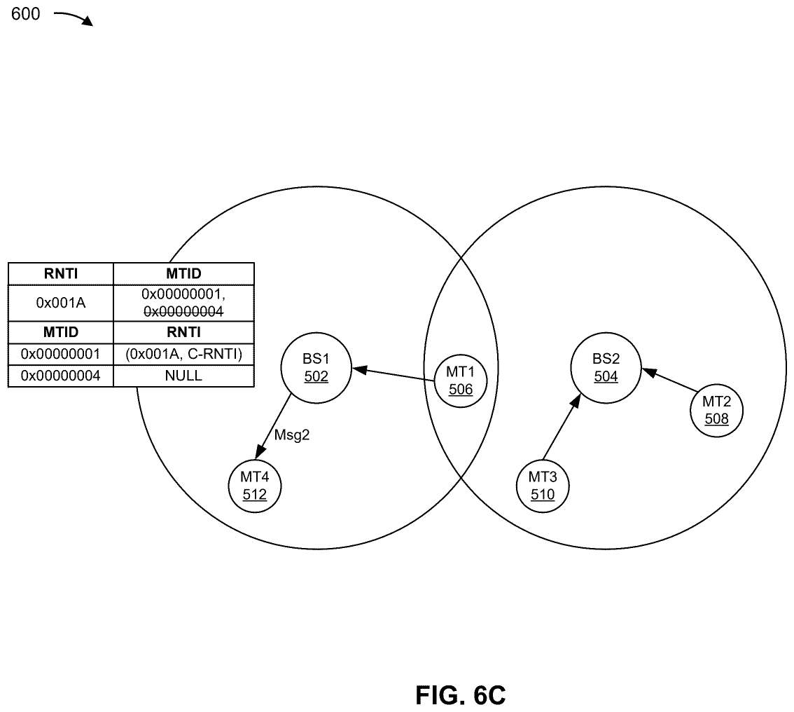

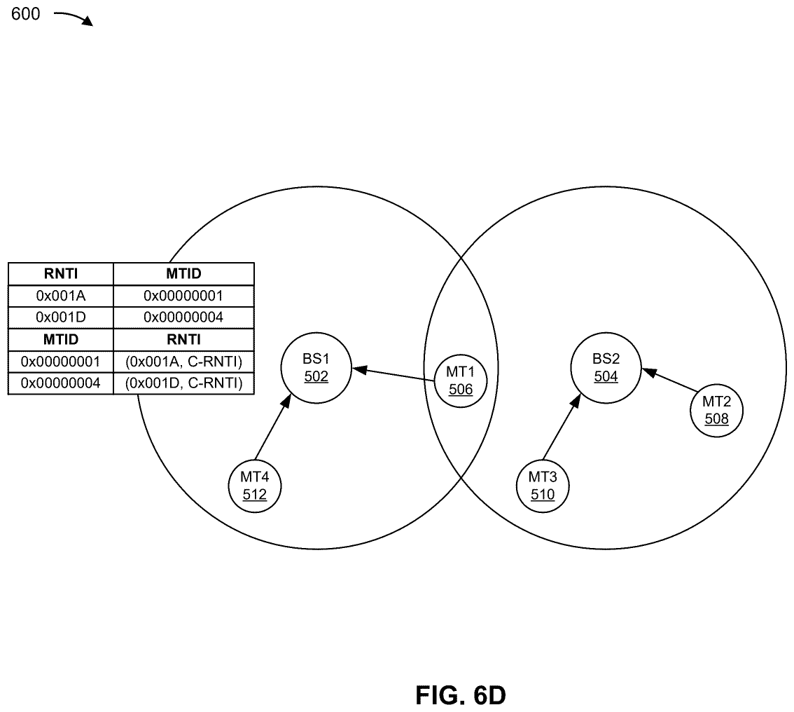

FIGS. 6A-6D are diagrams of an example 600 associated with mapping RNTIs and MTIDs in a wired simulation environment. As shown in FIGS. 6A-6D, example 600 includes a first BS (BS1) 502, a second BS (BS2) 504, a first MT (MT1) 506, a second MT (MT2) 508, a third MT (MT3) 510, and a fourth MT (MT4) 512. In some implementations, in the case of duplicate RNTIs, an RA-RNTI selected by one MT may be equal to a C-RNTI of a served MT.

As shown in FIG. 6A, the first MT 506 may be connected to the first BS 502. The third MT 510 and the fourth MT 512 may be connected to the second BS 504. The fourth MT 512 may not be served by any BS. The first BS 502 may maintain an RNTI-to-MTID hash table and an MTID-to-RNTI hash table, where the RNTI-to-MTID hash table may be used for an RNTI-to-MTID mapping and the MTID-to-RNTI hash table may be used for an MTID-to-RNTI mapping. For example, the RNTI-to-MTID hash table may map 0x001A to 0x00000001, and the MTID-to-RNTI hash table may map 0x00000001 to (0x001A, C-RNTI).

As shown in FIG. 6B, the fourth MT 512 may transmit a Msg1 to the first BS 502, which may occur after the fourth MT 512 moves to be within coverage of the first BS 502. For example, the BS 502 may perform operations of UPDATE(MTID-to-RNTI, 0x00000004, (0x001A, RA-RNTI)) and UPDATE(RNTI-to-MTID, 0x001A, 0x00000004.

As shown in FIG. 6C, the first BS 502 may transmit a Msg2 (e.g., RAR message) to the fourth MT 512. When transmitting the Msg2, the first BS 502 may check whether the fourth MT 512 (e.g., an intended MT) has an RNTI that is marked as an RA-RNTI in the MTID-to-RNTI hash table. The first BS 502 may only transmit the Msg2 to an MT (e.g., the fourth MT 512) that has sent the Msg1. The first BS 502 may only transmit the Msg2 to the fourth MT 512 and not to the first MT 506. For example, the first BS 502 may perform the following operations. When A=GET(RNTI-to-MTID, 0x001A), for each a in A, the first BS 502 may perform B=GET(MTID-to-RNTI, a). When TYPE(B)=RA-RNTI, then the first BS 502 may begin a procedure to transmit Msg2. Further, the first BS 502 may perform operations of DELETE(MTID-to-RNTI, B), and when P=FIND(RNTI-to-MTID, 0x001A, a), DELETE(RNTI-to-MTID, P).

As shown in FIG. 6D, the fourth MT 512 may become synchronized with the first BS 502. For example, the first BS 502 may perform operations of UPDATE(MTID-to-RNTI, 0x00000004, (0x001D, C-RNTI)) and UPDATE(RNTI-to-MTID, 0x001D, 0x00000004.

As indicated above, FIGS. 6A-6D are provided as an example. Other examples may differ from what is described with regard to FIGS. 6A-6D. The number and arrangement of devices shown in FIGS. 6A-6D are provided as an example. In practice, there may be additional devices, fewer devices, different devices, or differently arranged devices than those shown in FIGS. 6A-6D. Furthermore, two or more devices shown in FIGS. 6A-6D may be implemented within a single device, or a single device shown in FIGS. 6A-6D may be implemented as multiple, distributed devices. Additionally, or alternatively, a set of devices (e.g., one or more devices) shown in FIGS. 6A-6D may perform one or more functions described as being performed by another set of devices shown in FIGS. 6A-6D.

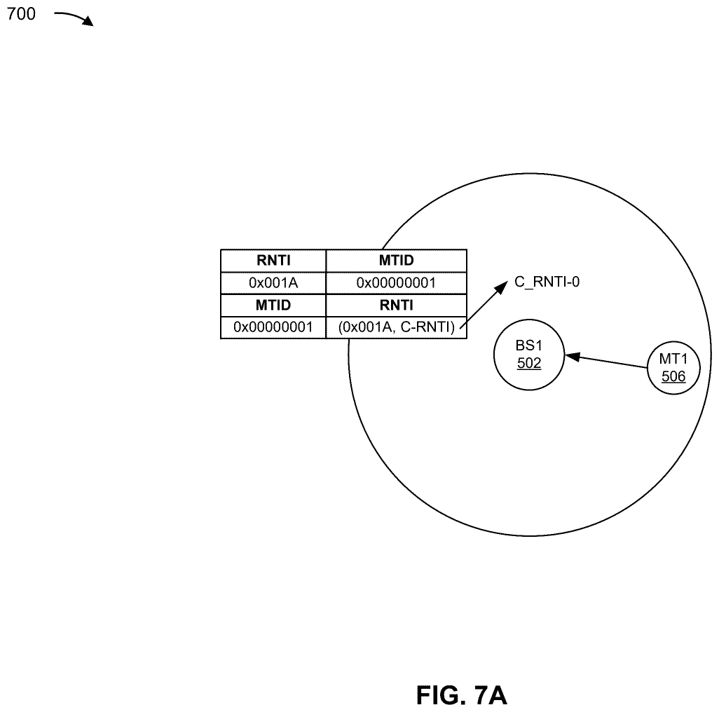

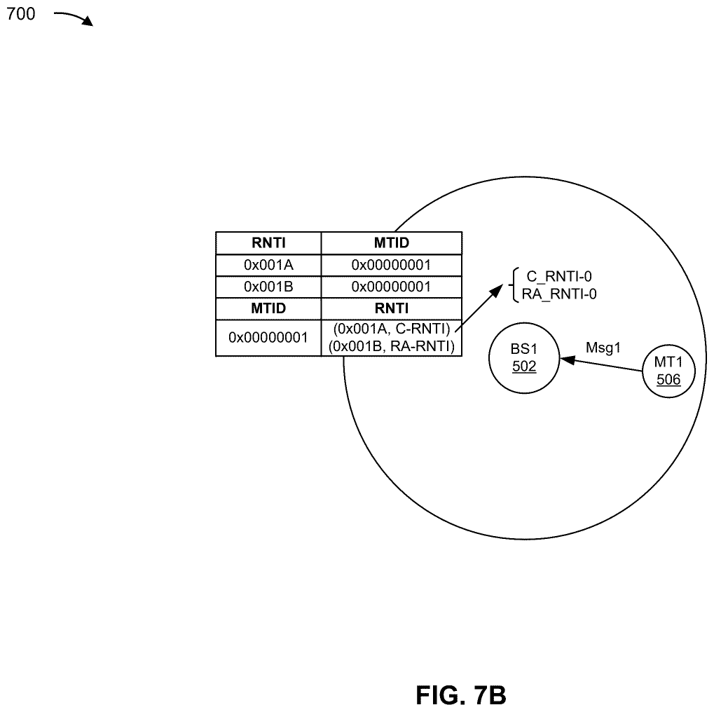

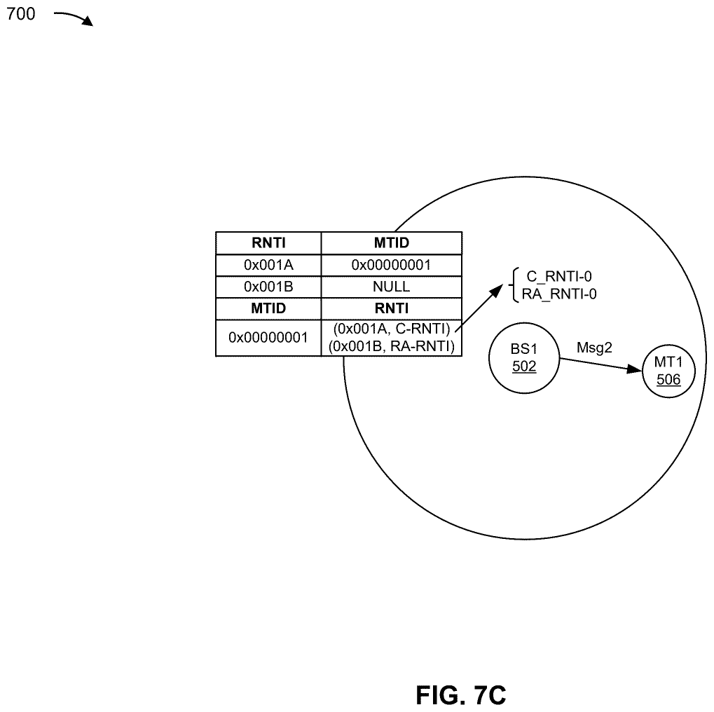

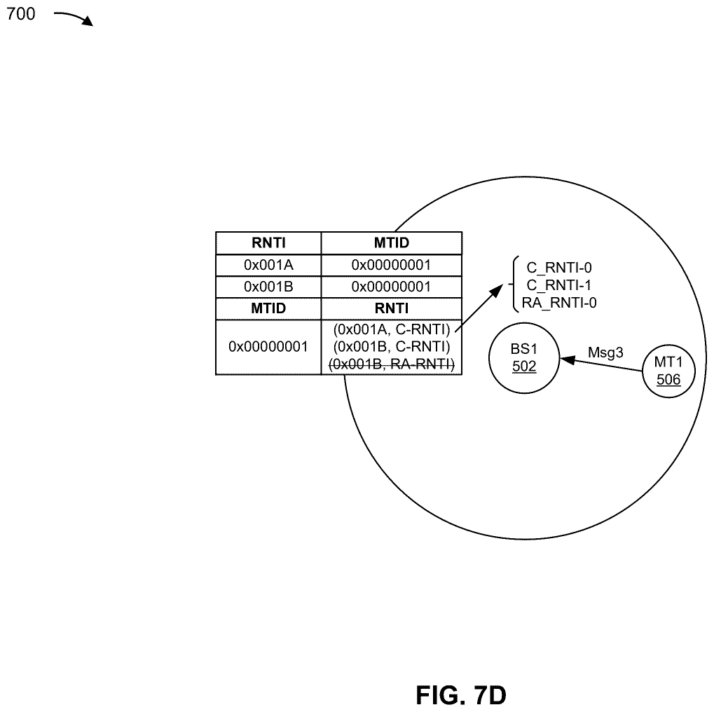

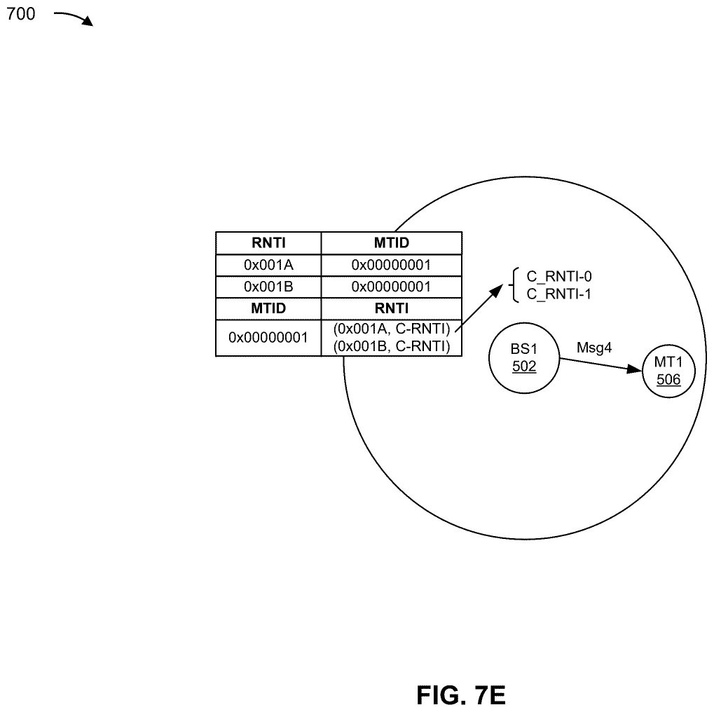

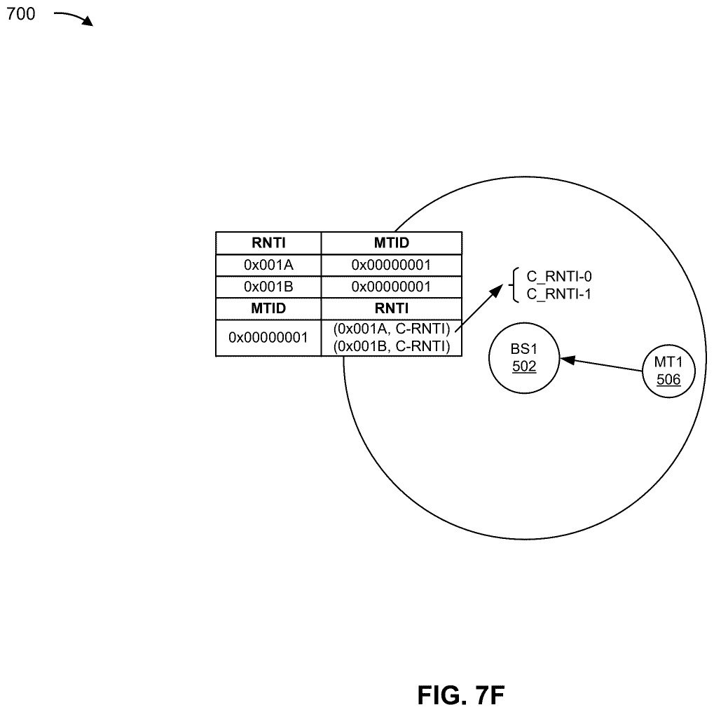

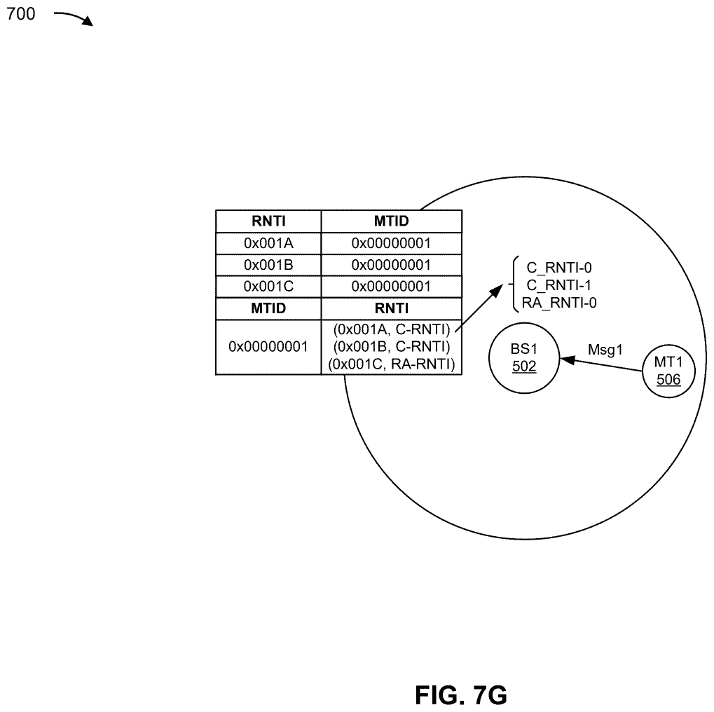

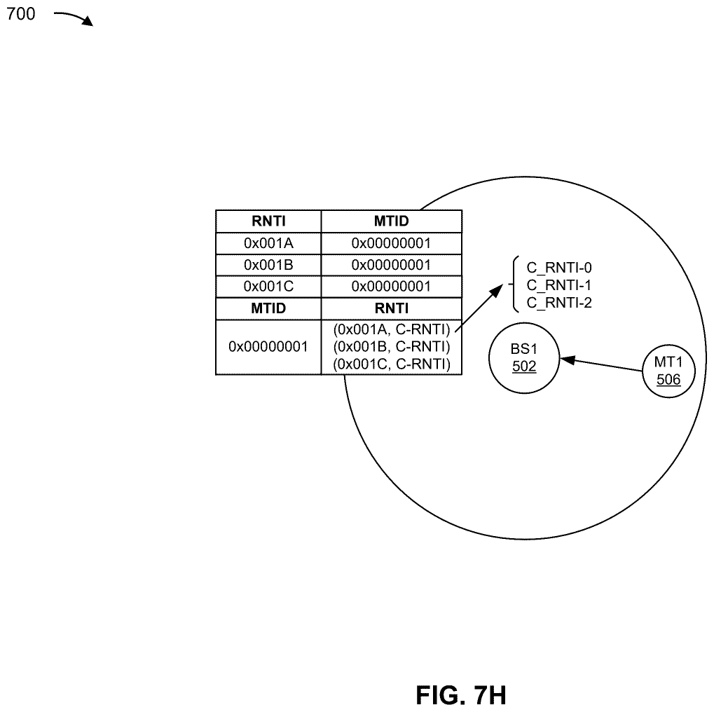

FIGS. 7A-7H are diagrams of an example 700 associated with mapping RNTIs and MTIDs in a wired simulation environment. As shown in FIGS. 7A-7H, example 700 includes a first BS (BS1) 502 and a first MT (MT1) 506.

In some implementations, in the case of multiple RNTIs, more than one C-RNTI may be present during a radio resource control (RRC) reestablishment. In this case, an RRC connected MT may undergo a random access procedure to receive another C-RNTI.

As shown in FIG. 7A, the first MT 506 may be in an RRC connected state with respect to the first BS 502. The first BS 502 may maintain an RNTI-to-MTID hash table and an MTID-to-RNTI hash table, where the RNTI-to-MTID hash table may be used for an RNTI-to-MTID mapping and the MTID-to-RNTI hash table may be used for an MTID-to-RNTI mapping. For example, the RNTI-to-MTID hash table may map 0x001A to 0x00000001, and the MTID-to-RNTI hash table may map 0x00000001 to (0x001A, C-RNTI).

In some implementations, during a served state of the first MT 506, a process for a non-contention random access procedure (e.g., as shown in FIG. 2) may be followed. In addition, when duplicate RNTIs exist, a procedure for handling duplicate RNTIs (e.g., as shown in FIGS. 6A-6B) may be followed.

As shown in FIG. 7B, the first MT 506 may undergo a random access procedure, in which case the first BS 502 may receive a Msg1 from the first MT 506. The first MT 506 may undergo the random access procedure when being in the RRC connected state. The first BS 502 may perform operations associated with updating the RNTI-to-MTID hash table and/or the MTID-to-RNTI hash table, which may be based on the reception of the Msg1 from the first MT 506.

As shown in FIG. 7C, the first BS 502 may transmit a Msg2 to the first MT 506. The first BS 502 may perform operations associated with updating the RNTI-to-MTID hash table and/or the MTID-to-RNTI hash table, which may be based on the transmission of the Msg2 to the first MT 506.

As shown in FIG. 7D, the first BS 502 may receive a Msg3 from the first MT 506. The first BS 502 may perform operations associated with updating the RNTI-to-MTID hash table and/or the MTID-to-RNTI hash table, which may be based on the reception of the Msg3 from the first MT 506.

As shown in FIG. 7E, the first BS 502 may transmit a Msg4 to the first MT 506. The first BS 502 may perform operations associated with updating the RNTI-to-MTID hash table and/or the MTID-to-RNTI hash table, which may be based on the transmission of the Msg4 to the first MT 506.

As shown in FIG. 7F, the first MT 506 may be in an RRC connected state with respect to the first BS 502. The first MT 506 may be in the RRC connected state after a completion of the random access procedure, which may involve signaling of the Msg1, the Msg2, the Msg3, and the Msg4.

As shown in FIG. 7G, the first MT 506 may undergo a second random access procedure, in which case the first BS 502 may receive another Msg1 from the first MT 506. The first BS 502 may perform operations associated with updating the RNTI-to-MTID hash table and the MTID-to-RNTI hash table, which may be based on the second random access procedure.

As shown in FIG. 7H, the first MT 506 may be in an RRC connected state again with respect to the first BS 502. The first MT 506 may be in the RRC connected state after a completion of the second random access procedure, which may involve signaling of the Msg1, the Msg2, the Msg3, and the Msg4. The first BS 502 may perform operations associated with updating the RNTI-to-MTID hash table and/or the MTID-to-RNTI hash table, which may be based on the second random access procedure. Further, after the second random access procedure, multiple RNTIs may exist in the RNTI-to-MTID hash table and/or the MTID-to-RNTI hash table until a duplicate RNTI arrives (e.g., which may be handled by the procedure shown in FIGS. 6A-6D).

As indicated above, FIGS. 7A-7H are provided as an example. Other examples may differ from what is described with regard to FIGS. 7A-7H. The number and arrangement of devices shown in FIGS. 7A-7H are provided as an example. In practice, there may be additional devices, fewer devices, different devices, or differently arranged devices than those shown in FIGS. 7A-7H. Furthermore, two or more devices shown in FIGS. 7A-7H may be implemented within a single device, or a single device shown in FIGS. 7A-7H may be implemented as multiple, distributed devices. Additionally, or alternatively, a set of devices (e.g., one or more devices) shown in FIGS. 7A-7H may perform one or more functions described as being performed by another set of devices shown in FIGS. 7A-7H.

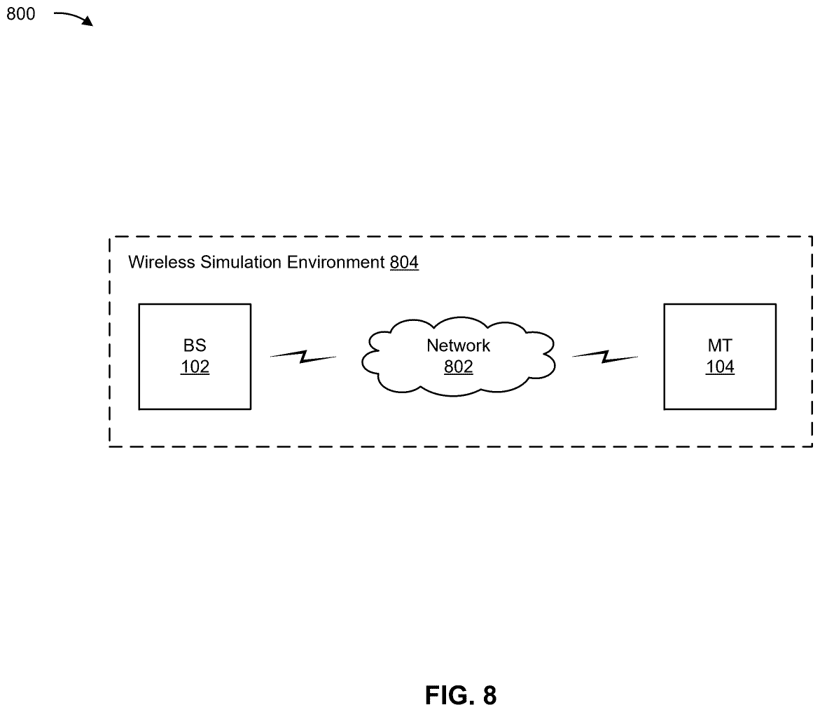

FIG. 8 is a diagram of an example environment 800 in which systems and/or methods described herein may be implemented. As shown in FIG. 8, environment 800 may include a BS 102, an MT 104, and a network 802. The BS 102, the MT 104, and the network 802 may be included in a wireless simulation environment 804. Devices of environment 800 may interconnect via wired connections, wireless connections, or a combination of wired and wireless connections.

The BS 102 may include one or more devices capable of receiving, generating, storing, processing, providing, and/or routing information associated with mapping RNTIs and MTIDs in the wired simulation environment 804, as described elsewhere herein. The BS 102 may include a communication device and/or a computing device. For example, the BS 102 may include a server, such as an application server, a client server, a web server, a database server, a host server, a proxy server, a virtual server (e.g., executing on computing hardware), or a server in a cloud computing system. In some implementations, the BS 102 may include computing hardware used in a cloud computing environment.

The MT 104 may include one or more devices capable of receiving, generating, storing, processing, providing, and/or routing information associated with mapping RNTIs and MTIDs in the wired simulation environment 804, as described elsewhere herein. The MT 104 may include a communication device and/or a computing device. For example, the MT 104 may include a server, such as an application server, a client server, a web server, a database server, a host server, a proxy server, a virtual server (e.g., executing on computing hardware), or a server in a cloud computing system. In some implementations, the MT 104 may include computing hardware used in a cloud computing environment.

The network 802 may include one or more wired and/or wireless networks. For example, the network 802 may include a cellular network (e.g., a 5G network, a fourth generation (4G) network, a Long Term Evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 802 enables communication among the devices of environment 800.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

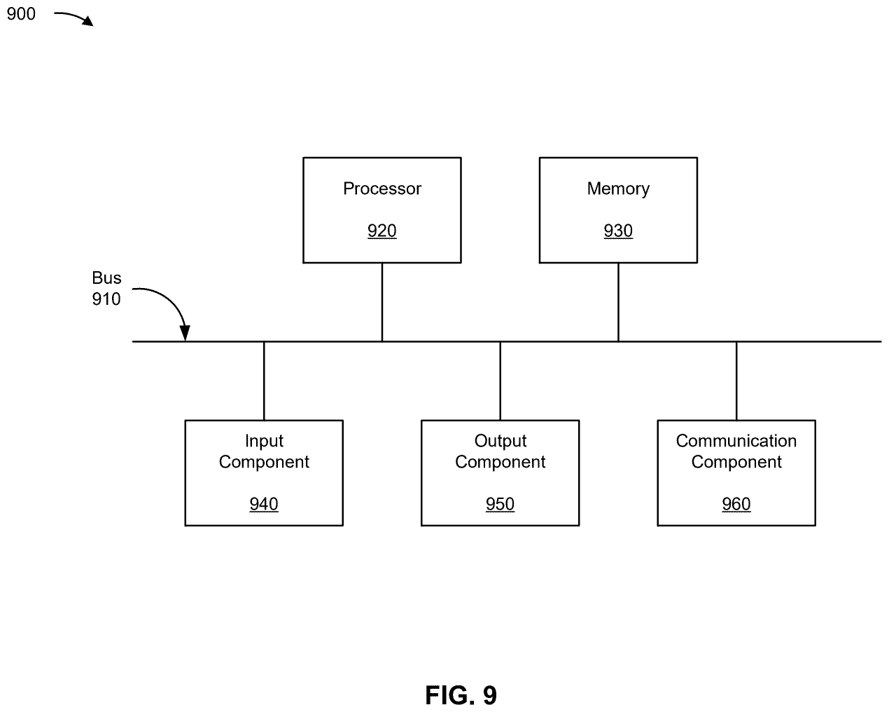

FIG. 9 is a diagram of example components of a device 900 associated with mapping RNTIs and MTIDs in a wired simulation environment. The device 900 may correspond to a BS (e.g., BS 102). In some implementations, the BS may include one or more devices 900 and/or one or more components of the device 900. As shown in FIG. 9, the device 900 may include a bus 910, a processor 920, a memory 930, an input component 940, an output component 950, and/or a communication component 960.

The bus 910 may include one or more components that enable wired and/or wireless communication among the components of the device 900. The bus 910 may couple together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 may include a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 may include one or more processors capable of being programmed to perform one or more operations or processes described elsewhere herein.

The memory 930 may include volatile and/or nonvolatile memory. For example, the memory 930 may include random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). The memory 930 may be a non-transitory computer-readable medium. The memory 930 may store information, one or more instructions, and/or software (e.g., one or more software applications) related to the operation of the device 900. In some implementations, the memory 930 may include one or more memories that are coupled (e.g., communicatively coupled) to one or more processors (e.g., processor 920), such as via the bus 910. Communicative coupling between a processor 920 and a memory 930 may enable the processor 920 to read and/or process information stored in the memory 930 and/or to store information in the memory 930.

The input component 940 may enable the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 may enable the device 900 to provide output, such as via a display, a speaker, and/or a light-emitting diode. The communication component 960 may enable the device 900 to communicate with other devices via a wired connection and/or a wireless connection. For example, the communication component 960 may include a receiver, a transmitter, a transceiver, a modem, a network interface card, and/or an antenna.

The device 900 may perform one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry may be used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

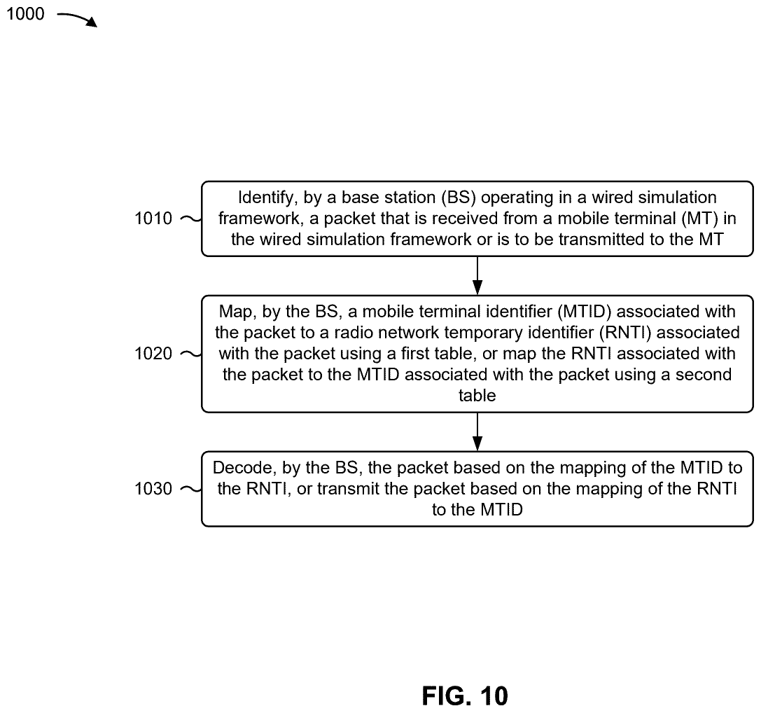

FIG. 10 is a flowchart of an example process 1000 associated with mapping RNTIs and MTIDs in a wired simulation environment. In some implementations, one or more process blocks of FIG. 10 may be performed by a BS (e.g., BS 102) of a wireless simulation environment. Additionally, or alternatively, one or more process blocks of FIG. 10 may be performed by one or more components of device 900, such as processor 920, memory 930, input component 940, output component 950, and/or communication component 960.

As shown in FIG. 10, process 1000 may include identifying, by the BS operating in a wired simulation framework, a packet that is received from an MT in the wired simulation framework or is to be transmitted to the MT (block 1010). The packet may be associated with a random access procedure during which the MT initially accesses the BS. The BS may be a first BS, and the packet may be associated with a handover of the MT from the first BS to a second BS. The packet may be associated with a scenario or use case involving duplicate RNTIs between MTs. The packet may be associated with a scenario or use case involving multiple RNTIs associated with the MT.

As further shown in FIG. 10, process 1000 may include mapping, by the BS, a mobile terminal identifier (MTID) associated with the packet to a radio network temporary identifier (RNTI) associated with the packet using a first table, or mapping the RNTI associated with the packet to the MTID associated with the packet using a second table (block 1020). In some implementations, the first table may be an MTID-to-RNTI hash table, the packet may be received from the MT, the packet may indicate the MTID, and the mapping may be from the MTID to the RNTI using the MTID-to-RNTI hash table. In some implementations, the second table may be an RNTI-to-MTID hash table, the packet may be transmitted to the MT, and the mapping may be from the RNTI to the MTID using the RNTI-to-MTID hash table. In some implementations, the mapping of the MTID to the RNTI or the mapping of the RNTI to the MTID may be based on one or more of: a get operation, an update operation, a find operation, or a delete operation on the first hash table or the second hash table. The RNTI may be an RA-RNTI, a TC-RNTI, or a C-RNTI. The MTID may be an IP address.

As further shown in FIG. 10, process 1000 may include decoding, by the BS, the packet based on the mapping of the MTID to the RNTI, or transmitting the packet based on the mapping of the RNTI to the MTID (block 1030). The BS may decode the packet based on the mapping from the MTID to the RNTI using the MTID-to-RNTI hash table. The BS may transmit the packet based on the mapping from the RNTI to the MTID using the RNTI-to-MTID hash table.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a base station (BS) operating in a wired simulation framework, a packet that is received from a mobile terminal (MT) in the wired simulation framework or is to be transmitted to the MT;
mapping, by the BS, a mobile terminal identifier (MTID) associated with the packet to a radio network temporary identifier (RNTI) associated with the packet using a first table, or mapping the RNTI associated with the packet to the MTID associated with the packet using a second table; and
decoding, by the BS, the packet based on the mapping of the MTID to the RNTI, or transmitting the packet based on the mapping of the RNTI to the MTID.

2. The method of claim 1, wherein the first table is an MTID-to-RNTI hash table, the packet is received from the MT, the packet indicates the MTID, and the mapping is from the MTID to the RNTI using the MTID-to-RNTI hash table.

3. The method of claim 1, wherein the second table is an RNTI-to-MTID hash table, the packet is transmitted to the MT, and the mapping is from the RNTI to the MTID using the RNTI-to-MTID hash table.

4. The method of claim 1, wherein the mapping of the MTID to the RNTI or the mapping of the RNTI to the MTID is based on an operation on the first table or the second table, and the operation is one or more of:
a get operation,
an update operation,
a find operation, or
a delete operation.

5. The method of claim 1, wherein the RNTI is one of: a random access RNTI, a temporary cell RNTI, or a cell RNTI.

6. The method of claim 1, wherein the MTID is an Internet Protocol address.

7. The method of claim 1, wherein the packet is associated with a random access procedure during which the MT initially accesses the BS.

8. The method of claim 1, wherein the BS is a first BS, and wherein the packet is associated with a handover of the MT from the first BS to a second BS.

9. The method of claim 1, wherein the packet is associated with a use case involving duplicate RNTIs between MTs.

10. The method of claim 1, wherein the packet is associated with a use case involving multiple RNTIs associated with the MT.

11. A device, comprising:
one or more processors configured to:
identify a packet that is received from a mobile terminal (MT) in a wired simulation framework or is to be transmitted to the MT;
map a mobile terminal identifier (MTID) associated with the packet to a radio network temporary identifier (RNTI) associated with the packet using a first table, or map the RNTI associated with the packet to the MTID associated with the packet using a second table; and
decode the packet based on the map of the MTID to the RNTI, or transmit the packet based on the map of the RNTI to the MTID.

12. The device of claim 11, wherein:
the first table is an MTID-to-RNTI hash table, the packet is received from the MT, the packet indicates the MTID, and the mapping is from the MTID to the RNTI using the MTID-to-RNTI hash table; or
the second table is an RNTI-to-MTID hash table, the packet is transmitted to the MT, and the mapping is from the RNTI to the MTID using the RNTI-to-MTID hash table.

13. The device of claim 11, wherein the map of the MTID to the RNTI or the map of the RNTI to the MTID is based on an operation on the first table or the second table, and the operation is one or more of:
a get operation,
an update operation,
a find operation, or
a delete operation.

14. The device of claim 11, wherein the RNTI is one of: a random access RNTI, a temporary cell RNTI, or a cell RNTI, and the MTID is an Internet Protocol address.

15. The device of claim 11, wherein:
the packet is associated with a random access procedure during which the MT initially accesses a base station (BS) in the wired simulation framework;
the BS is a first BS, and the packet is associated with a handover of the MT from the first BS to a second BS;
the packet is associated with a use case involving duplicate RNTIs between MTs; or
the packet is associated with a use case involving multiple RNTIs associated with the MT.

16. A non-transitory computer-readable medium storing a set of instructions, the set of instructions comprising:
one or more instructions that, when executed by one or more processors of a device, cause the device to:
identify a packet that is received from a mobile terminal (MT) in a wired simulation framework or is to be transmitted to the MT;
map a mobile terminal identifier (MTID) associated with the packet to a radio network temporary identifier (RNTI) associated with the packet using a first table, or map the RNTI associated with the packet to the MTID associated with the packet using a second table; and
decode the packet based on the map of the MTID to the RNTI, or transmit the packet based on the map of the RNTI to the MTID.

17. The non-transitory computer-readable medium of claim 16, wherein:
the first table is an MTID-to-RNTI hash table, the packet is received from the MT, the packet indicates the MTID, and the mapping is from the MTID to the RNTI using the MTID-to-RNTI hash table; or
the second table is an RNTI-to-MTID hash table, the packet is transmitted to the MT, and the mapping is from the RNTI to the MTID using the RNTI-to-MTID hash table.

18. The non-transitory computer-readable medium of claim 16, wherein the map of the MTID to the RNTI or the map of the RNTI to the MTID is based on an operation on the first table or the second table, and the operation is one or more of:
a get operation,
an update operation,
a find operation, or
a delete operation.

19. The non-transitory computer-readable medium of claim 16, wherein the RNTI is one of: a random access RNTI, a temporary cell RNTI, or a cell RNTI, and the MTID is an Internet Protocol address.

20. The non-transitory computer-readable medium of claim 16, wherein:
the packet is associated with a random access procedure during which the MT initially accesses a base station (BS) in the wired simulation framework;
the BS is a first BS, and the packet is associated with a handover of the MT from the first BS to a second BS;
the packet is associated with a use case involving duplicate RNTIs between MTs; or
the packet is associated with a use case involving multiple RNTIs associated with the MT.
